(19) United States
(12) Patent Application Publication
(10) Pub. No.: US 2014/0279156 A1
(43) Pub. Date: Sep. 18, 2014

(54) Method and Computer Medium for Facilitating a Buyer-initiated Transaction in Commerce

(71) Applicant: D. Ernest Sparks, Vista, CA (US)

(72) Inventor: D. Ernest Sparks, Vista, CA (US)

(21) Appl. No.: 14/214,106

(22) Filed: Mar. 14, 2014

Related U.S. Application Data
(60) Provisional application No. 61/782,300, filed on Mar. 14, 2013.

(51) Int. Cl. G06Q 30/08; G06Q 20/10; G06Q 30/06

(52) U.S. Cl. CPC G06Q 30/08; G06Q 30/0623; G06Q 20/10
USPC 705/26.3; 705/26.61

(57) ABSTRACT

A buyer-initiated method, system and business model for matching parties interested in conducting an internet initiated transaction is described. Through the use of this method, a request is placed by buyer at a client server system. Sellers can receive a response to a purchaser's request via the client server system by one or more methods such as: 1) Entering a search term of at least one word, or; 2) if a seller has buyer's request, seller automatically receives notification by one or more electronic methods such as an internet communication or a telecommunication text message. Sellers may search client server's database for a buyer's request for a product or service the seller controls or owns. An escrow service is provided by the business model should clients prefer a secure transaction. The system and model of the present invention can generate revenue streams from buyers and sellers for the service provided.

### CONTINUITY

This application is a non-provisional application of provisional application No. 61/782,300 filed on Mar. 14, 2013 and priority is claimed thereto.

### FIELD OF THE PRESENT INVENTION

The present disclosure relates to software to facilitate electronic commerce, and in particular bringing buyers and sellers together through a product or service search engine.

### BACKGROUND OF THE PRESENT INVENTION

Symptomatic of most internet search engines is that they typically produce far more results than required. Most of these search results have little or nothing to do with the input submitted. As such, it is often more difficult than necessary for buyers to find quality products from a variety of sellers without wading through sub-optimal results. Likewise, it can be difficult for sellers to easily reach their target market to facilitate sale of their products when they can be easily lost in a vast assortment of search results, many of which are frequently unrelated to the desired target, or only loosely related.

Thus, there is a need for a method and system to help eliminate time and unnecessary action on the part of buyers and sellers in contacting each other for purposes of carrying out successful transactions of commerce online.

Others have attempted to solve this issue with a variety of online services, however most are not concerned with gaining a large database of buyers, but instead generally concentrate on aggregating sellers to display to a buyer when a buyer performs a search. Conversely, the system of the present invention is preferably configured to entice buyers to submit requests for wanted items or services to the system, and sellers are preferably charged in order to search the database of buyers to find a target to sell to and establish negotiations.

U.S. patent application Ser. No. 14/064,623, filed by Manoel Tenorio on Oct. 28, 2013 is for a system for “Pre-Qualifying Sellers During the Matching Phase of an Electronic Commerce Transaction.” Tenorio teaches a similar system to the present invention in that sellers are matched with buyers in order to facilitate a transaction, however the database Tenorio teaches is primarily configured to house lists of sellers, unlike the present invention, which maintains a database of buyers, yielding a group of searchable buyers to be used by sellers citing specific search criteria.

### SUMMARY OF THE PRESENT INVENTION

The present invention is a system and process for expediting the connection made between buyers and sellers via a specialized search and response process. Through the use of this method, a request is placed by buyer at a client server system. Sellers can receive a response to a purchaser's request via a client server system in a variety of ways described herein.

The following presents a simplified summary in order to provide a basic understanding of some aspect of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of various exemplary embodiments, a method for matching parties interested in conducting a network transaction is provided, the method comprising: Conveying at least one search to a user for narrowing an item or service to transact, providing for display a location for entering at least one buyer search term, providing for display a location for entering at least one seller search term, receiving at least one search term from at least one buyer, receiving at least one search term from at least one seller, matching parties for an internet transaction, and notifying parties for an internet transaction.

In another aspect of various exemplary embodiments, a computer readable volatile or nonvolatile store medium carrying one or more sequences of instruction which, when executed by one or more processors, causes the one or more processors to execute a method for matching parties interested in conducting a network transaction.

This method comprising: Conveying at least one search to a user for narrowing an item or service to transact, providing for display a location for entering at least one buyer search term, providing for display a location for entering at least one seller search term, receiving at least one search term from the buyer, receiving at least one search term from the seller, matching parties for an internet transaction, and notifying parties through a network of a match.

In yet another aspect of various exemplary embodiments, a method for a buyer to locate a seller through a network is provided, the method comprising: Receiving at least one word search on an electronic display, entering at least one search term in the electronic display, publishing the at least one search term to the network and receiving at least one response from at least one pre-qualified seller.

In yet another aspect of various exemplary embodiments, a method for a seller to locate a buyer through a network is provided, the method comprising: Receiving at least one word search, entering at least one search term, publishing the at least one search term, and receiving at least one response from at least one pre-qualified buyer.

### BRIEF DESCRIPTION OF THE DRAWINGS

FIG. 1 is a block diagram of an exemplary embodiment of the method of the present invention for matching parties interested in conducting network transactions.

FIG. 2 is a block diagram of an exemplary embodiment method for buyer registration for the purpose of conducting a network transaction.

FIG. 3 is a block diagram of an exemplary embodiment method for seller registration for the purpose of conducting a network transaction.

FIG. 4 is a block diagram of an exemplary embodiment method for a prospective buyer to create a registration profile for the purpose of conducting a network transaction.

FIG. 5 is a block diagram of an exemplary embodiment method for a prospective seller to create a registration profile for the purpose of conducting a network transaction.

FIG. 6 is a block diagram of an exemplary embodiment method for a searchable server database for the purpose of matching parties interested in conducting a network transaction.

FIG. 7 is a flow chart of an exemplary embodiment method of an internet transaction of commerce between a buyer and a seller.

FIG. 8 is a flow chart of an exemplary embodiment method of a buyer registering and completing an internet transaction of commerce with a seller.

FIG. 9 is a flow chart of an exemplary embodiment method of a seller registering and completing an internet transaction of commerce with a buyer.

### DETAILED DESCRIPTION OF THE PREFERRED EMBODIMENT

In the following detailed descriptions of various exemplary embodiments, reference is made to the accompanying drawings that form a part hereof, and in which is shown, by way of illustration, specific embodiments that may be practiced. It is to be understood that other embodiments may be utilized and structural changes may be made without departing from the scope of the present disclosure.

The present invention is a system and method for conducting internet commerce online via a networked computer system that expedites and facilitates the process of matching buyers to sellers via an organic streamlined search and matching algorithm. The preferred embodiment of the present invention employs text fields on a visual display

Turning now to the figures, each figure will now be described in greater detail:

FIG. 1 is a block diagram embodying an internet environment (100) in which the user (101) elects to become either a buyer (102) or a seller (103) and uses the network (104) to negotiate and complete a commercial transaction through the use of a server (105). FIG. 2 is a block diagram representing a buyer (102) who creates a registration profile (106) and establishes bargaining terms (107) for a commercial transaction.

FIG. 3 depicts a block diagram representing a seller (103) who creates a registration profile (107), and selects bargaining terms and status level (108).

FIG. 4 shows a block diagram representing the registration profile (106) of a buyer (102). The buyer (102) creates a username (110) and a password (115), and completes registration credentials (111) by selecting a form of payment (112), shipping address (113) and contact information (114).

FIG. 5 details a block diagram representing the registration profile (107) of a seller (103). The seller (103) creates a username (110) and a password (115), and completes registration by selecting a form of payment (112), shipping address (113), contact information (114), and the seller status as either active (116) or passive (117).

FIG. 6 exhibits a block diagram representing a searchable server (118) including a a memory region (119) primary memory region (120) with software (121) designed to perform specific functions and a second memory (122) containing user profiles and other data required to adequately support the bargaining environment (FIG. 1, 100). A server database (123) is accessed via a network connection (124) and a computer processor (125) utilizing peripheral hardware (126) as required.

FIG. 7 depicts a flow chart showing an overall general representation of an internet transaction of commerce between a buyer and a seller. The process of the present invention will now be described.

The internet environment begins (Step 200) with a client selecting a status as either a buyer or a seller (Step 201). If the client selects status as a buyer (Step 202) then determination is made regarding buyer's registration status. If the buyer is not registered then buyer creates registration credentials (Step 203) and is assigned a unique identification.

Once a registered buyer logs on (Step 204) and enters a wanted request (Step 205), the request is entered into the server database (Step 206). If the server database (Step 206) does not produce an immediate match between the buyer's request and previously recorded keywords or keyword word phrase entered by a seller (Step 226) the buyer's request remains within the database (Step 206) for a specified number of days (Step 207). If no seller responds to a buyer's posted request within a specific number of days, the buyer's request is automatically removed (Step 208) from the server database. If the server database (Step 206) contains a keyword or combination of keywords previously recorded by a seller (Step 226) which matches the buyer's request, an automatic response (Step 210) is forwarded to the seller. After reviewing the wanted request (Step 211) the seller may either discard the notification and end the session (Step 213) or respond to the buyer (Step 209).

After reviewing the seller's response the buyer determines whether or not to respond back to the seller (Step 212). If buyer chooses not to respond to seller, the session ends (Step 213). If the buyer responds to seller and wishes to negotiate a transaction (Step 214) the seller is notified (Step 211). The seller can either end the session (Step 213) or enter into negotiations with the buyer (Step 214). If negotiations are not successful the session ends (Step 213). If negotiations are successful (Step 215) buyer and seller determine if they wish to complete the transaction using escrow services provided by the server (Step 216). If both buyer and seller agree escrow services are not required they complete the transaction (Step 218) and the session ends (Step 213). If buyer and seller agree to use escrow services provided by the client server (Step 217) the transaction is completed (Step 218) and the session ends (Step 213).

If a client enters the internet environment (Step 200) and elects status as a seller (Step 201) then a determination is made regarding seller's registration status (Step 219). If seller is not registered then seller creates registration credentials (Step 220) and is assigned a unique identification. Once a registered seller logs on (Step 221) determination is made as to seller's status (Step 222). If seller does not choose premium status, he may proceed to a display window as a non-premium seller and enter a search string containing a limited number of characters (Step 223). The client server determines if a match exists between the search string entered by the seller, and a request previously posted by a buyer (Step 224) in the server database (Step 206).

If no match exists, the seller may end the session (Step 213), or enter a new search string (Step 223). The seller is limited to the number of search strings which may be entered within a specified period of time. If the search string returns a positive match (Step 224) with a previously posted buyer's request (Step 205), the seller reviews the request (Step 211) and either rejects the response and ends the session (Step 213), or responds to the buyer (Step 209). After reviewing a seller's response the buyer determines whether or not to respond back to the seller (Step 212).

If buyer chooses not to respond to seller, the session ends (Step 213). If the buyer responds to seller and wishes to negotiate a transaction (Step 214) the seller is notified (Step 211). The seller can either end the session (Step 213) or enter into negotiations with the buyer (Step 214). If negotiations are not successful, the session ends (Step 213). If negotiations are successful (Step 215), the buyer and the seller determine if they wish to complete the transaction using escrow services provided by the server (Step 216). If the buyer and the seller determine escrow services are not required, they complete the transaction (Step 218) and the session ends (Step 213). If buyer and seller agree to use escrow services provided by the client server (Step 217), the transaction is completed (Step 218) and the session ends (Step 213).

If a seller chooses a premium status (Step 222), a specified number of key words may be entered (Step 226). Different levels of premium status are available to a seller and the total number of key words which may be entered into the server database (Step 206) is determined by the level of premium status selected by the seller. The premium seller may elect to combine two or more keywords before an automatic response is generated. After inputting complete premium status information, the seller may end the session (Step 213) and wait until automatically notified of a positive match (Step 210) by the client server or, if the seller wishes, he may proceed in the same manner as a non-premium seller, and enter a data search string (Step 223).

FIG. 8 is a flow chart representing the process followed when a potential buyer registers and completes an internet transaction with a seller possessing either premium or non-premium status who enters a search string to originate a search. After obtaining session identification (Step 300), registration status is determined (Step 301). An un-registered buyer (300A) becomes a registered buyer (300B) by acquiring registration credentials (300E), and creating a registration profile (300F) including, but not limited to, a user name (300G), a password (300H), and an identification number (300J). Once registration is completed, the buyer is signed in (Step 303) and may either end the session (Step 304), or proceed to a display window (Step 305) and enter a wanted request (300K) consisting of a limited number of characters.

The request is posted to the client server database (Step 306) for a limited number of days. If no response is received by a registered seller (300C) within the specified period of time the buyer's request is removed from the client server database (Step 307). If a premium seller (300C) or non-premium seller (300D) initiates a search by entering keywords in a display window (Step 308), and a successful match (Step 309) is made with a wanted request (300K) previously posted to the server database (Step 306) by a buyer (300B), then the seller, after examining the buyer's request, may either terminate the search (Step 310) and enter another search string (Step 308), end the session (Step 304), or respond to the buyer (Step 311). After the buyer (300B) receives the seller's response (Step 311), the buyer (300B) examines the seller's offer, he may either end the session (Step 304) or agree to negotiate terms with seller (Step 313). If the buyer responds to the seller's response (Step 311), the buyer's balance of remaining search requests (300K) is reduced by one.

If the buyer and seller cannot agree on terms, the transaction is terminated (Step 316), and the session ends (Step 304). If a buyer and a seller agree on terms of the transaction (Step 315), they then determine if the escrow services of the client server (Step 319) are to be used for a secure transaction (Step 317). If buyer and seller cannot agree to use the escrow service, the transaction may either be terminated (Step 318) and the session ended (Step 304), or they may agree to complete the transaction without the use of the escrow service and complete the transaction (Step 320). If buyer and seller agree to use the client escrow services (Step 319), the transaction is completed (Step 320) and the session ends (Step 304).

It should be noted that multiple sellers may respond to a wanted request posted by a buyer, and that negotiations between a buyer and multiple sellers may be simultaneous. If the buyer chooses, he or she can leave the request active and continue to receive responses from sellers to complete unlimited transactions via the request within a predefined time limit. However, the request is automatically removed after a specified number of days. Similarly, the buyer may also opt to remove the request manually, independently of the pre-established timeout. If the buyer removes the request without responding to a seller, the buyer is not charged.

FIG. 9 is a flow chart representing the process followed when a potential seller registers and completes an internet transaction by initiating a search of the client server database via the process of the present invention. The prospective seller (400A) obtains session identification (Step 400) and determines status (Step 401). If client is not a registered seller client obtains seller status by acquiring registration credentials (400E) and creating a registration profile (400F) including, but not limited to, a user name (400G), a password (400H), an identification number (400J), and a method of payment (400K) which may include, but is not limited to, a credit or debit card, a direct link to a bank account, or any other method of legally transmitting funds.

Once registration is completed (Step 402) client selects status (Step 403) as either a premium seller (400B) or a non-premium seller (400C). If seller elects premium status (400B), seller selects one of several different premium levels and enters the number of keywords permitted by the chosen level (Step 404). A premium seller (400B) may also require a combination of two or more keywords to match a wanted request (400L) posted by a registered buyer (400D) in the client server database (Step 409) before being notified of a wanted request (400L). The premium seller (400B) may sign off (Step 405) ending the session (Step 406) and wait for an automatic response to a buyer's request (400L) or initiate a search (Step 408). If a seller (400B) initiates a search (Step 408) and a match is successful (Step 410) with a buyer's previously posted request (400L) in the server database (Step 409), the seller examines the buyer's request (400L) to make a determination as to whether a successful transaction is possible.

If seller (400B) concludes a transaction is not possible, he may sign off (Step 405) and end the session (Step 406), or initiate another search (Step 408). If a successful match (Step 410) is returned by the server database (Step 409) and the seller (400B) determines a transaction is possible, the seller (400B) may contact (Step 411) the buyer (400D) with information which may generate enough interest by the buyer (400D) to respond (Step 412) to the seller (400B) and agree on terms of a transaction (Step 413).

If the buyer (400D) determines the information provided by the seller (400B) would not lead to a successful transaction, buyer may end the session (Step 406). If buyer (400D) and seller (400B) agree to terms of a transaction (Step 413), they then determine if the escrow service (Step 416) provided by the client server is needed for a secure transaction (Step 415). If buyer (400D) and seller (400B) agree to complete the transaction without use of the client server escrow service (Step 416) they complete the transaction (Step 417) and the session ends (Step 406). If buyer (400D) and seller (400B) cannot mutually agree to use the escrow service (Step 416) they may either terminate the session (Step 406) or agree to complete the transaction (Step 417) without the benefit of the escrow service (Step 416) and the session ends (Step 406).

If a client completes registration (Step 402) and chooses (Step 403) non-premium status (400C) seller is log in (Step 407) and either chooses to sign off (Step 405) and end the session (Step 406) or initiate a search (Step 408) and proceed in the same manner as a premium seller (400B).

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

In summation, the following elements of the present invention should be understood: Buyers are not charged a fee by the system of the present invention in order to list a request and be added to the database. The buyer (400D) is only charged a fee, preferably $0.99, if and when the buyer initiates negotiations with a seller that has contacted the buyer. The seller (400B) is charged a fee by the system of the present invention only when the seller (400B) searches for buyers' requests via the searchable database to respond to. The cost the seller (400B) pays to search for buyers varies in accordance with how many search terms are used, and therefore the specificity of the search. Search strings can employ conventional logic cues such ‘and’ and ‘or.’ When the seller (400B) finds an acceptable buyer (400D) to respond to, the seller sends a pre-written or ‘canned’ response to the buyer (400D), informing the buyer (400D) of the item or service for sale from the seller (400B). The seller (400B) may not send free-form messages to the buyer (400D), and may preferably only send the ‘canned’ responses in order to prevent the seller (400D) from enticing the buyer (400D) to complete and consummate the sale via a source external to the system of the present invention.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for matching parties interested in conducting a network transaction via a computer, the method comprising:
the computer conveying at least one search to a user for narrowing an item to transact;
the computer displaying a location for entering at least one buyer search term;
the computer displaying a location for entering at least one seller search term;
the computer receiving at least one search term from at least one buyer;
the computer receiving at least one search term from at least one seller;
the computer matching parties consisting of relating at least one buyer and at least one seller for an internet transaction; and,
notifying parties for an internet transaction.

2. The method of claim 1, wherein the at least one buyer has a user account protected by log-in credentials.

3. The method of claim 1. wherein the at least one buyer search term has a predetermined value.

4. The method of claim 1, wherein the at least one seller search term has a predetermined value.

5. The method of claim 1, wherein the at least one buyer search term is published on a network to the at least one seller with a user account.

6. The method of claim 1, wherein matching parties for an internet transaction is performed by computer instructions that pair the user with the at least one buyer search term with the user with the at least one seller search term.

7. The method of claim 1, wherein computer instructions notify the users through a network of a successful match.

8. A method to connect buyers and sellers via a computer comprising:
the computer executing one or more sequences of instructions, initiating the following process comprising:
the computer conveying at least one search to a user for narrowing an item to transact;
the computer providing for display a location for entering at least one buyer search term;
the computer providing for display a location for entering at least one seller search term;
the computer receiving at least one search term from the buyer;
the computer receiving at least one search term from the seller;
the computer matching the buyer to the seller for an internet transaction;
the computer displaying results of the at least one search term from the seller to the seller, results consisting of a list of buyers;
the computer deducting at least one credit from an account of the seller;
the computer notifying the buyer and seller of the match through a network;
the computer receiving notice that the buyer has commenced negotiations with the seller; and
the computer deducting one credit from an account of the buyer after negotiations have commenced.

9. The method of claim 8, wherein the buyer has a first user account protected by log-in credentials
wherein the seller has a second user account protected by log-in credentials.

10. The method of claim 8. Wherein the at least one buyer search term has a predetermined value.

11. The method of claim 8, wherein the at least one seller search term has a predetermined value.

12. The method of claim 8, wherein the at least one buyer search term is published on a network to the at least one seller with a user account.

13. The method of claim 8, wherein matching parties for an internet transaction is performed by computer instructions that pair the user with the at least one buyer search term with the user with the at least one seller search term.

14. The method of claim 8, wherein computer instructions notify the users through a network of a successful match.

15. A method for a buyer to locate a seller through a computer via a network, the method comprising:
the computer receiving at least one word search on an electronic display;
the buyer entering at least one search term on the electronic display;
the computer publishing the at least one search term to the network;
the computer pre-qualifying at least one seller tailored to the at least one search term from the buyer; and,
the computer distributing at least one response from at least one pre-qualified seller to the buyer.
